(19) United States
(12) Patent Application Publication
(10) Pub. No.: US 2025/0162573 A1
(43) Pub. Date: May 22, 2025

(54) Driving System and Method for the Automated Maneuvering of a Motor Vehicle Based on a Recorded Driving Maneuver

(71) Applicant: Bayerische Motoren Werke Aktiengesellschaft, Muenchen (DE)

(72) Inventor: Mohamad Mounir EL DANA, Muenchen (DE)

(21) Appl. No.: 18/727,404

(22) PCT Filed: Jan. 20, 2023
(86) PCT No.: PCT/EP2023/051305

§ 371 Date: Jul. 9, 2024

(30) Foreign Application Priority Data
Jan. 21, 2022 (DE) 10 2022 101 348.0

(51) Int. Cl. B60W 30/06; B60W 50/14

(52) U.S. Cl. CPC B60W 30/06; B60W 50/14; B60W 2050/146; B60W 2420/403; B60W 2520/04; B60W 2540/215; B60W 2556/10; B60W 2556/50

(57) ABSTRACT

A driving system for automated maneuvering of a motor vehicle based on a recorded driving maneuver of the motor vehicle is provided. The driving system is configured to detect that a recorded driving maneuver is available at a destination of a travel of the motor vehicle, which destination is specified by a user. In response thereto, the driving system is further configured to cause the motor vehicle to be maneuvered in an automated manner at the destination based on the recorded driving maneuver.

### BACKGROUND AND SUMMARY

The invention relates to a driving system and to a corresponding method for the automated guidance, in particular maneuvering, of a motor vehicle according to a stored driving maneuver.

A vehicle can have a driving system, in particular a maneuvering system, which permits the user of the vehicle to maneuver the vehicle in an automated manner on the basis of a driving trajectory which has been stored in advance, e.g., to guide the vehicle longitudinally and/or laterally in an automated manner along the stored driving trajectory on a parking space of a parking area. In this context, the driving system can be designed to automatically detect, e.g., on the basis of GNSS sensor data and/or on the basis of odometer data, that the vehicle is in close proximity to the stored driving trajectory. On the basis thereof, an offer to guide the vehicle in an automated manner, in particular to maneuver the vehicle in an automated manner, can be output to the user via a user interface.

The offer to carry out a recorded driving maneuver may be overlooked by the driver of the vehicle. Furthermore, the driver may feel uncomfortable about evaluating and, optionally, accepting an offer for a recorded driving maneuver while driving the vehicle manually.

The present document addresses the technical problem of increasing the comfort of a driving system for carrying out recorded driving maneuvers.

The problem is solved by each of the independent claims. Advantageous embodiments are described, among other things, in the dependent claims. It is pointed out that additional features of a patent claim, which is dependent on an independent patent claim, can form an invention, which is separate and independent of the combination of all features of the independent claim, without the features of the independent patent claim or only in combination with a subset of the features of the independent patent claim, which can be made the subject matter of an independent claim, a divisional application, or a subsequent application. This applies in a similar way for technical teachings described in the description, which can form an invention independent of the features of the independent patent claims.

According to one aspect, a driving system, in particular a maneuvering system, for the automated guidance, in particular for the automated maneuvering, of a motor vehicle is described. In a driving system of this type, the driver can record an implemented driving maneuver, in particular an implemented positioning maneuver. Via self-localization, the driving system can, for example, detect when the motor vehicle is located at a possible activation point for a stored driving maneuver and make an offer to the driver to automatically carry out the stored maneuver. According to the invention, in the maneuver which is carried out in an automated manner (also referred to as replication), the system can adhere as exactly as possible to the driving maneuver specified by the driver (in particular to a recorded driving trajectory) provided that the vehicle surroundings permit this.

The automation mode of the driving system can optionally be started only at one possible activation point and/or in an activation region, at which the automated guidance, in particular the automated maneuvering, on the basis of the recorded driving trajectory can begin. For example, it can be provided that a possible activation point is present when the motor vehicle is located precisely on the recorded trajectory of the recorded driving maneuver. In an alternative embodiment, a possible activation point is present when the current distance of the motor vehicle to the recorded trajectory of the recorded driving maneuver is less than or equal to a threshold value (e.g., 0.5 m) and the vehicle is therefore arranged in a predefined activation region; a supplemental trajectory for the recorded trajectory can then be determined in order to guide the motor vehicle in an automated manner from the activation point onto the recorded trajectory and, from there, to follow the recorded trajectory.

The driving system is designed to record (in a recording mode) a driving trajectory for a driving maneuver in a certain road area on the basis of the path of travel traversed by the driver using the motor vehicle in a manual driving operation (with manual longitudinal guidance and/or with manual lateral guidance). The recorded driving trajectory is designed such that the driving trajectory is usable in the automation mode of the driving system for an automated driving maneuver (in particular for automated maneuvering). In the recording mode, a recorded trajectory for the recorded driving maneuver can therefore be determined and stored.

The driving system can be designed to store, in the recording mode, at least one possible activation point, at which an automated driving maneuver can be carried out in the automation mode of the driving system on the basis of the recorded driving trajectory.

The expression “automated maneuvering” or “automated driving” is understood as set forth in the document to mean maneuvering, or driving, with automated longitudinal and/or lateral guidance. The expression “automated maneuvering” or “automated driving” includes automated maneuvering, or driving, with any degree of automation. Exemplary degrees of automation are assisted, semi-automated, highly automated, fully automated, and autonomous driving (with an increasing degree of automation in each case). The five aforementioned degrees of automation correspond to the SAE levels 1 through 5 of the SAE J3016 standard (SAE—Society of Automotive Engineering). In assisted driving (SAE level 1), the system carries out the longitudinal or lateral guidance in certain driving situations. In semi-automated driving (SAE level 2), the system takes over the longitudinal and lateral guidance in certain situations, and the driver must permanently monitor the system as is also the case during assisted driving. In highly automated driving (SAE level 3), the system takes over the longitudinal and lateral guidance in certain driving situations without the need for the driver to permanently monitor the system; however, the driver must be able to take over the guidance of the vehicle within a certain period of time upon request by the system. In fully automated driving (SAE level 4), the system takes over the guidance of the vehicle in certain driving situations even if the driver does not respond to a request to engage, and therefore the driver does not apply as fallback support. In autonomous driving (SAE level 5), all aspects of the dynamic driving operation can be carried out by the system under any road and environmental conditions which are also handled by a human driver.

The driving system can be designed to output, via a user interface (of the vehicle and/or of a mobile user device), an offer to the driver of the vehicle to carry out an automated driving maneuver on the basis of the recorded driving trajectory when it is determined that the vehicle is located in a proximity region of the recorded driving trajectory (the proximity region typically being larger than the activation region of the recorded trajectory). The driver can then accept the offer in order to induce the automated driving maneuver to be carried out.

The driving system can therefore be designed to record, in a recording mode, a driving trajectory for a driving maneuver on the basis of the path of travel traversed by the driver using the vehicle in a manual driving operation, and to store this as a recorded driving maneuver, in particular on a memory unit in the vehicle. Furthermore, position data (such as GNSS coordinates, or coordinates of a GNSS) can be determined in relation to the recorded driving maneuver, in particular in relation to the proximity region, a near region, and/or the activation region of the recorded driving maneuver, and stored. Position data can be determined and stored, the position data allowing the proximity region, the near region, and/or the activation region of the recorded driving maneuver to be determined (e.g., calculated). Furthermore, the driving system can be designed such that, in an automation mode, the driving system longitudinally and/or laterally guides the vehicle in an automated manner on the basis of the recorded trajectory of the recorded driving maneuver when the vehicle is driven on another journey, in order to carry out the recorded driving maneuver in an automated manner.

Therefore, a driving system (such as a maneuvering system) for carrying out a recorded driving maneuver (such as a positioning maneuver) of a motor vehicle in an automated manner is described in this document. The automated execution of a recorded driving maneuver can include, in particular, the automated maneuvering on the basis of the recorded driving maneuver, in particular on the basis of the recorded trajectory of the recoded driving maneuver.

The driving system is designed to detect that a (previously) recorded driving maneuver is available at a destination on a journey of the motor vehicle specified by the user of the vehicle (in particular at a specified destination address). The recorded driving maneuver can be selected and/or identified (on the basis of the specified destination) from a list of different recorded driving maneuvers. The recorded driving maneuver can include a positioning maneuver at the destination (e.g., parking in a garage or in a parking bay in an automated manner).

The journey of the vehicle can begin at a starting location and extend to the destination (and terminate at the destination). At the starting location (e.g., prior to or at the beginning of the journey), the destination can be specified by the user (e.g., via input into a navigation system of the vehicle). The vehicle can then be at least partially or fully manually driven by the driver to the destination. At the destination, the recorded driving maneuver can then be optionally carried out in an automated manner when this is desired by the user of the vehicle.

The driving system can therefore be designed to detect, prior to arrival at the destination (e.g., directly when the destination is specified), that a recorded driving maneuver is available at the destination. In response thereto, the driving system can then induce the recorded driving maneuver to be automatically carried out at the destination. In particular, the driving system can induce the motor vehicle to be maneuvered at the destination in an automated manner on the basis of the recorded driving maneuver. This can be induced, in particular, in response to the offer having been accepted by the user. This enables the comfort of the driving system to be increased.

The driving system can be designed to output an offer to carry out the recorded driving maneuver in an automated manner prior to the arrival at the destination. The offer can be output via a user interface in the vehicle and/or via a user device (e.g., a smartphone or a tablet PC) of the user.

The driving system can also be designed to detect (via the user interface), prior to the arrival at the destination, a user input by the user of the vehicle in response to the output of the offer to carry out the recorded driving maneuver in an automated manner. On the basis of the user input, it can be determined that the user desires that the recorded driving maneuver be carried out in an automated manner upon arrival at the destination. In particular, it can be determined on the basis of the user input that the user accepts the offer.

Furthermore, in response thereto, the driving system can automatically induce the recorded driving maneuver to be carried out in an automated manner upon arrival at the destination without a new offer being output. In particular, an automated longitudinal and/or lateral guidance of the vehicle on the basis of the recorded trajectory of the recorded driving maneuver can be induced.

The driving system therefore allows, prior to arrival at the destination of a journey, interaction with the user, in particular with the driver, of the vehicle, in order to determine whether an available (previously) recorded driving maneuver is to be carried out, or not, upon arrival at the destination. This user interaction can in particular take place directly when the destination is specified. This enables a new user interaction during the journey, in particular upon arrival at the destination, to be omitted. This enables the comfort for the user of the vehicle to be increased.

The driving system can be designed to detect, via the user interface (of the vehicle or of the user device), a user input for specifying the destination. In (direct) response thereto (e.g., within a time period of 10 seconds or fewer, or of 5 seconds or fewer once the destination has been specified), the output of the offer to carry out the recorded driving maneuver in an automated manner, in particular via the user interface, can be induced.

Alternatively or additionally, the driving system can be designed to output the offer to carry out the recorded driving maneuver in an automated manner within the framework of specifying the destination and/or within the framework of planning a driving route to the destination. Alternatively or additionally, the offer to carry out the recorded driving maneuver in an automated manner can be output prior to or at the beginning of the journey to the destination. Alternatively or additionally, the driving system can be designed to induce the output of the offer to carry out the recorded driving maneuver in an automated manner when the destination is entered into the navigation system of the vehicle, or in response thereto (i.e., within the framework thereof).

The user interaction for selecting the recorded driving maneuver can therefore preferably take place prior to the beginning of the (manual) journey to the destination. This enables the comfort of the driving system to be further increased.

The driving system can be designed to detect, during the journey to the destination (which is carried out, e.g., at least partially manually by the user), that the vehicle has reached the activation region of the recorded driving maneuver (which is arranged, e.g., at a defined distance, approximately 0.5 m, about the recorded trajectory). In response thereto, without a new offer being output, the execution of the recorded driving maneuver in an automated manner can be automatically induced (i.e., maneuvering the vehicle on the basis of the recorded driving maneuver can be automatically induced).

In particular, the driving system can be designed to induce (via the user interface) the output of a stop request to stop the vehicle in response to the detected arrival at the activation region of the recorded driving maneuver. Furthermore, it can be detected that the vehicle has come to a standstill in the activation region (due to the output of the stop request). In response thereto, the vehicle can then be longitudinally and/or laterally guided in an at least partially automated manner or in a fully automated manner on the basis of and/or along the recorded trajectory of the recorded driving maneuver, in order to automatically carry out the recorded driving maneuver.

The automated execution of the recorded driving maneuver can therefore be started automatically (without further output of an offer) upon arrival at the activation region. This enables the comfort of the driving system to be further increased.

The driving system can be designed to detect, during the journey to the destination, that the vehicle has arrived at the near region of the recorded driving maneuver (the near region typically being larger than the activation region). In response thereto, an output of support information can be automatically induced, without a new offer to carry out the recorded driving maneuver in an automated manner being output, the support information being intended to assist the driver of the vehicle during the approach to the activation region of the recorded driving maneuver. The output support information can display, e.g., a path, with which the vehicle can be (manually) guided to the activation region. Due to the output of support information, the comfort of the driving system can be further increased.

The driving system can be designed to determine, during the journey to the destination, on the basis of Global Navigation Satellite System (GNSS) data (i.e., on the basis of coordinates of a GNSS) and/or on the basis of image data of at least one surroundings camera of the vehicle, that the vehicle has arrived at the proximity region of the recorded driving maneuver (the proximity region typically being larger than the near region).

In response thereto, positioning the recorded trajectory of the recorded driving maneuver relative to the vehicle coordinate system of the vehicle can be automatically induced, in particular without a new offer to carry out the recorded driving maneuver in an automated manner being output.

Alternatively or additionally, an odometry-based distance of the vehicle from the recorded trajectory can be determined and/or repeatedly updated. Optionally, image data from one or more surroundings camera(s) of the vehicle can also be taken into account in the determination of the odometry-based distance. In particular, the odometry-based distance can (optionally also) be determined on the basis of the image data from one or more surroundings camera(s) of the vehicle (e.g., on the basis of visual odometry). It can be particularly precisely determined on the basis of the odometry-based distance that the vehicle has arrived at the near region and/or the activation region of the recorded driving maneuver. This enables the reliability of the driving system to be further increased.

The driving system can be designed to determine position data, in particular GNSS coordinates (e.g., GPS coordinates), of the destination. Furthermore, position data, in particular GNSS coordinates, of the recorded driving maneuver, in particular position data for determining and/or relevant to the proximity region, the near region, and/or the activation region of the recorded driving maneuver, can be determined. The position data can be read out, e.g., from a memory unit (of the vehicle). It can then be identified, on the basis of the position data of the destination and of the recorded driving maneuver, that the recorded driving maneuver is arranged at the destination.

The driving system can be designed, in particular, to determine position data for a plurality of different recorded maneuvers. The recorded driving maneuver which is available at the destination can then be identified from the plurality of recorded driving maneuvers on the basis of the position data of the destination and on the basis of the position data for the plurality of recorded driving maneuvers.

Due to the determination of position data, it can be particularly reliably identified that a recorded driving maneuver is available for a specified destination of a driving route. This enables the reliability of the driving system to be further increased.

As described above, the new output of an offer upon arrival at the destination can be omitted due to the user interaction for specifying the automated execution of the recorded driving maneuver prior to the arrival at the destination. Optionally, upon arrival at the destination, a message can be output to the user (via the user interface) indicating that the recorded driving maneuver is being carried out in an automated manner (in particular, that the vehicle is maneuvered in an automated manner on the basis of the recorded driving maneuver). The user can be optionally provided with the option of stopping and/or preventing the (already activated) execution of the recorded driving maneuver by means of a user input. This enables the comfort for the user to be further increased.

According to a further aspect, a (road) motor vehicle (in particular a passenger car or a truck or a bus) is described, which includes the driving system described in this document.

According to a further aspect, a method is described for the automated execution of a recorded driving maneuver of a motor vehicle (in particular for the automated maneuvering of a motor vehicle on the basis of a recorded driving maneuver of the motor vehicle). The method includes detecting that a recorded driving maneuver is available at a destination on a journey of the motor vehicle specified by a user. Furthermore, the method can include, in response thereto, inducing the recorded driving maneuver to be automatically carried out at the destination. Alternatively or additionally, the method can include outputting, prior to the arrival at the destination, an offer to carry out the recorded driving maneuver in an automated manner at the destination.

According to a further aspect, a software (SW) program is described. The SW program can be designed to be run on a processor (e.g., on a control unit of a vehicle), and, as a result, carry out the method described in this document.

According to a further aspect, a memory medium is described. The memory medium can include a SW program, which is designed to be run on a processor, and, as a result, carry out the method described in this document.

It is important to note that the methods, devices, and systems described in this document can be utilized alone as well as in combination with other methods, devices, and systems described in this document. Moreover, any aspects of the methods, devices, and systems described in this document can be combined with each other in various ways. In particular, the features of the claims can be combined with each other in various ways. Furthermore, features presented in brackets are to be understood as optional features.

The invention is described in greater detail in the following on the basis of exemplary embodiments, wherein:

### BRIEF DESCRIPTION OF THE DRAWINGS

FIG. 1 shows an exemplary vehicle with a driving system;

FIGS. 2a and 2b show a flowchart of an exemplary method for carrying out an automated driving maneuver;

FIG. 3 shows an exemplary proximity region, an exemplary near region, and an exemplary activation region;

FIGS. 4a and 4b show an exemplary display of the driving system, which is displayed in the motor vehicle;

FIG. 5 shows a flowchart of an exemplary method for operating a driving system; and

FIG. 6 shows an exemplary display for specifying a destination.

### DETAILED DESCRIPTION OF THE DRAWINGS

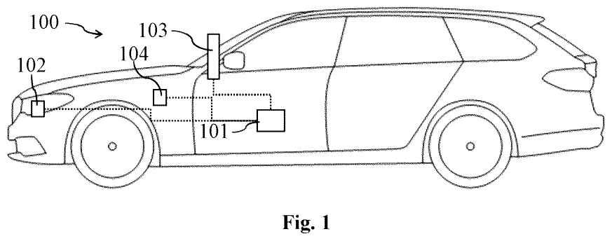

As described at the outset, the present invention relates to increasing the comfort of a vehicle driving system during a journey based on a recorded trajectory. In this context, FIG. 1 shows an exemplary vehicle 100, which includes one or more surroundings sensor(s) 102 for acquiring surroundings data, i.e., sensor data, related to the surroundings of the vehicle 100. The one or more surroundings sensor(s) 102 can include: a front surroundings sensor system which is directed forward as viewed by the driver, a side surroundings sensor system which is directed toward the left, a side surroundings sensor system which is directed toward the right, and/or a rear surroundings sensor system which is directed rearward. The front and the rear surroundings sensor systems can each include multiple ultrasonic sensors and, preferably, one or more camera(s). Optionally, a radar sensor system and/or a LIDAR sensor system can be present. The side surroundings sensor systems can each include one or more ultrasonic sensor(s) and, preferably, one or more camera(s).

The surroundings data of the one or more surroundings sensor(s) 102 can be received by an electronic control unit 101 for automated guidance, in particular maneuvering. The electronic control unit 101 for automated guidance can control an electronic head unit 103 (or, generally, a user interface) and can receive information therefrom. The head unit 103 can be used to control a central touch-sensitive screen in the vehicle cockpit and to receive input signals actuated via the touch-sensitive screen. The control unit 101 for automated guidance can be designed to control a transmission control unit, a steering control unit, and/or a prime mover control unit (i.e., one or more longitudinal and/or lateral guidance actuators 104) of the vehicle 100, in particular in order to guide the vehicle 100 longitudinally and/or laterally in an at least partially automated manner.

The driving system is designed to record, in a recording mode, a driving trajectory on the basis of a path of travel traversed by the driver using the motor vehicle 100 in the manual driving operation. In so doing, the following, for example, is recorded at regular path distances (e.g., once every 50 cm) on the manually traversed path of travel for the associated vehicle position (for example, relative to the center of the rear axle of the vehicle 100 as a reference position) as a sampling point of the trajectory:
GNSS-based vehicle position coordinates (GNSS—Global Navigation Satellite System); and/or
odometry-based vehicle position coordinates and/or the vehicle orientation; and/or
camera data (e.g., image data from one or more camera(s) of the vehicle 100).

The driving system is also designed to maneuver in an automated manner, in an automation mode, on the basis of the recorded driving trajectory of the motor vehicle 100, starting at a possible activation point for automated maneuvering.

The driving system can also include an approach mode for assisting the manual approach by the vehicle 100 to the recorded trajectory (which has been recorded in the manual driving operation). Within the framework of the approach mode, support information regarding the current position of the recorded driving trajectory in relation to the motor vehicle 100 can be output to the driver and, therefore, in the manual driving operation, the motor vehicle 100 can be guided to the recorded driving trajectory and, as a result, to a possible activation point for automated maneuvering, by using the support information.

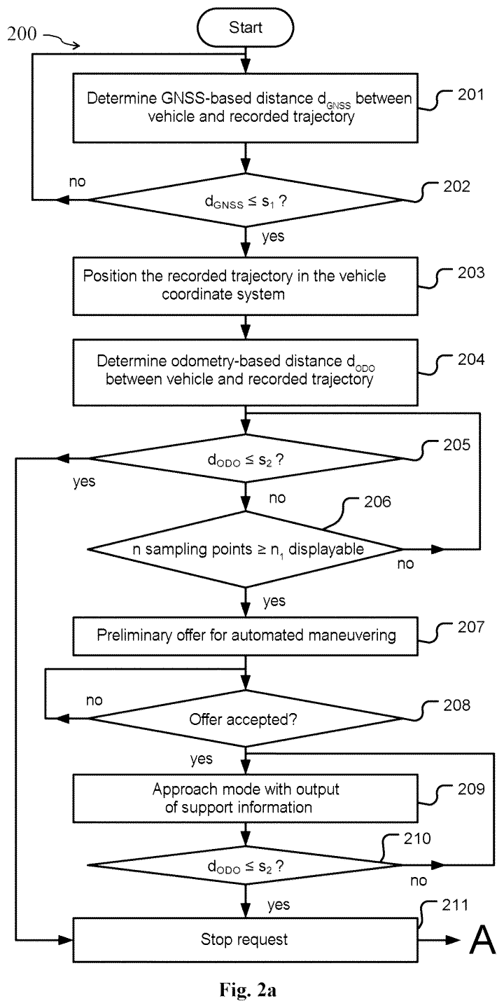

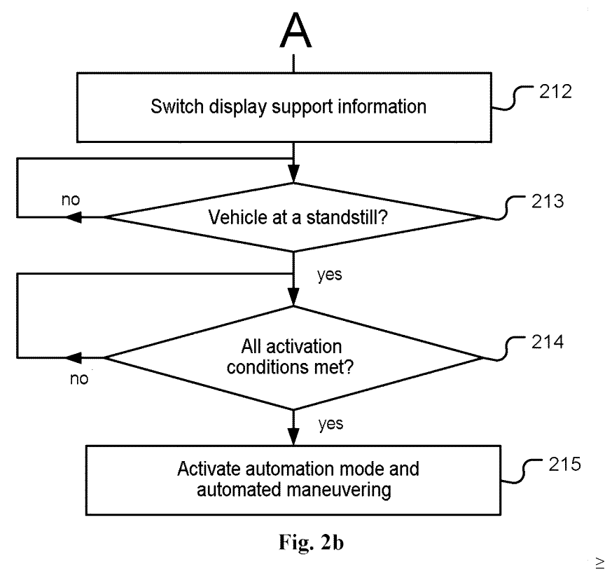

FIGS. 2a and 2b show a flowchart of an exemplary method 200 for the activation and function of the driving system, in particular in conjunction with the approach mode.

In step 201, the distance dGNSS between the driver's own motor vehicle 100 and a recorded driving trajectory in the vehicle 100 is repeatedly determined (if multiple driving trajectories have been recorded for various driving maneuvers, this is optionally carried out for each driving trajectory). The distance determination is preferably started only once a certain limiting speed (e.g., 30 km/h) has been fallen below. Optionally, the distance dGNSS can be determined only for the recorded driving maneuver which has already been selected for a destination.

The distance dGNSS can be determined on the basis of the stored GNSS-based position coordinates of all points on the trajectory and/or on the basis of the current GNSS-based position coordinates of the motor vehicle 100. The distance dGNSS is, for example, the minimum distance to the points on the trajectory.

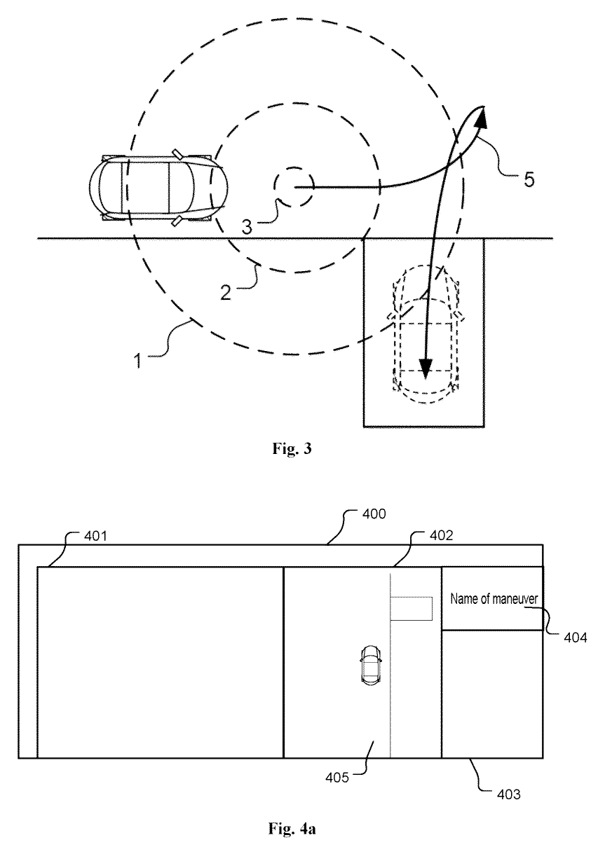

When it is established in step 202 that the distance dGNSS to a recorded maneuver (or to the already selected driving maneuver) is less than or equal to a predefined threshold value s1 (e.g., s1=10 m), the system can begin with the more precise localization. This proximity region in a radius of, for example, s1=10 m about the route of a recorded driving maneuver 5 is shown in FIG. 3 using the reference character 1.

Within the framework of the more precise localization, in step 203 the recorded driving trajectory is positioned in the vehicle coordinate system. In step 204, an odometry-based distance dODO between the driver's own vehicle 100 and the recorded trajectory 5 in the vehicle coordinate system is then determined, the distance dODO being characterized by greater accuracy (in comparison to the GNSS-based distance dGNSS) and the distance dODO preferably being the minimum distance to the points on the recorded trajectory 5. Preferably, additional camera information from one or more camera(s) 102 of the vehicle 100 is used to determine the distance dODO.

In the query 205, a check is carried out to determine whether the odometry-based distance dODO between the driver's own vehicle 100 and the recorded trajectory 5 is less than or equal to the threshold value s2 (e.g. with s2=1.0 m). When this is the case, the motor vehicle 100 is already located in a possible activation position and thus in an activation region, which is labeled with the reference character 3 in FIG. 3, about the recorded trajectory 5. An automated driving maneuver can be started in the activation region 3.

If the odometry-based distance dODO is greater than the threshold value s2, a check is carried out to determine whether the motor vehicle 100 is already located in a near region about the recorded trajectory 5. To this end, a check is carried out to determine whether at least n1 (e.g., n1=3) or more sampling points on the recorded trajectory are already displayable on a surroundings display shown on the screen (see query 206). The near region, which is labeled with the reference character 2 in FIG. 3, typically begins, for example, depending on the situation, at a distance in the magnitude of approximately 2 m to 3 m about the stored trajectory 5. When the motor vehicle 100 is located in the near region 2, the user can obtain a preliminary offer for automated maneuvering (see step 207) via the screen, and the stored maneuver can be displayed on the screen, such that the driver can manually drive the vehicle 100 to the activation region 3.

As is described in this document, the recorded driving maneuver with the recorded trajectory 5 can have been selected prior to the arrival at the destination. In this case, the output of a (further) preliminary offer for automated maneuvering can be prevented. Nevertheless, the stored maneuver can be displayed on the screen (without the preliminary offer being output).

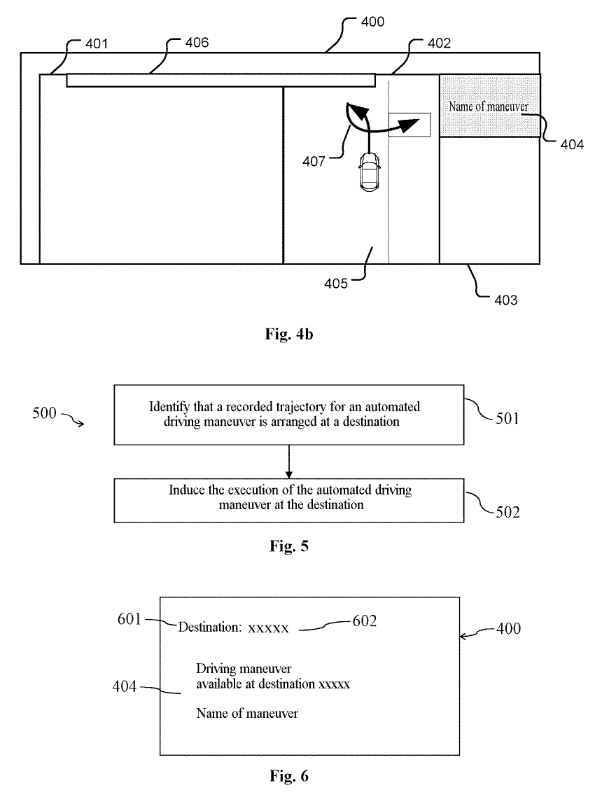

The output of a preliminary offer is shown in FIG. 4a by way of example. The display 400 in FIG. 4a has an ego surroundings display 401 (not shown in greater detail in FIG. 4a) with a camera-based display of the surroundings in the direction of travel from the ego perspective and a top-view surroundings display 402 in a top view, which is composed of multiple camera images. In the top-view surroundings display 402, the immediate surroundings are shown, for example, in a limited manner due to the range of the ultrasonic sensors. Instead of a camera-based view, a non-camera-based view would also be conceivable, in which, for example, the outlines of the objects or symbols for the objects are displayed. Furthermore, possible driving maneuvers can be displayed in a maneuver display 403. In FIG. 4a, a selection field 404 with the display of the name of a stored maneuver is displayed as a preliminary offer. The user can accept the preliminary offer by touching the selection field 404 or by operating a central operating element.

As is described in this document, the output of a preliminary offer, which is shown in FIG. 4a, can be omitted if the recorded driving maneuver was selected prior to the arrival at the destination, in particular prior to the arrival at the proximity region 1 of the recorded driving maneuver.

Provided that it is established in the query 208 in FIG. 2a (or via the preceding selection of the recorded driving maneuver) that the driver has accepted the preliminary offer, in step 209 the approach mode can be activated and support information regarding the current position of the recorded driving trajectory 5 in relation to the motor vehicle 100 can be output to the driver, such that, in the manual driving operation, the motor vehicle 100 is guidable to the recorded driving trajectory and, as a result, to a possible activation point for automated maneuvering by using the support information. In FIG. 4b, the recorded driving trajectory (or at least a portion of the driving trajectory) is output as support information 407 in the surroundings display 402 in the correct position in relation to the position of the motor vehicle 100. The driving trajectory is also preferably displayed in the ego surroundings display 401 (not shown in FIG. 4b). Furthermore, the driver receives a request, via a text overlay 406, to drive closer to the recorded trajectory in order to start the automated maneuvering (e.g., “To start the maneuver, please drive closer to the recorded path”). The displayed position of the trajectory is continually updated to reflect the change in the position of the motor vehicle 100.

When it is established in the query 210 that, due to the approach to the trajectory, the odometry-based distance dODO between the driver's own vehicle 100 and the recorded trajectory is less than or equal to the threshold value s2, the motor vehicle 100 is located in the activation region 3 and, in step 211, the driver receives a stop request in the form of an appropriate text overlay 406 (e.g., “To start the recorded driving maneuver, please stop the vehicle.”). Furthermore, in step 212, the display of the support information 407 is switched. To this end, for example, the color of the displayed trajectory is changed and the distance along the recorded trajectory to the end point of the trajectory is displayed. Furthermore, in addition, a supplemental trajectory which has been calculated by the driving system is optionally displayed (provided that this would not be concealed by the display of the ego vehicle 100), the vehicle 100 traversing the supplemental trajectory in an automated manner from the activation point to the stored trajectory.

A check is carried out in the query 213 in FIG. 2b to determine whether the vehicle has been decelerated to a standstill.

In the query 214, it is queried whether all activation conditions for automated maneuvering have been met.

The activation conditions include, in the exemplary embodiment, for example, one or more of the following conditions:
the motor vehicle 100 is (essentially) at a standstill,
the brake pedal of the motor vehicle 100 has been released by the driver,
the steering wheel of the motor vehicle 100 has been released by the driver,
the driver's seat belt is fastened,
a drive clearance for automated maneuvering has been issued for the steering system and the braking system of the vehicle 100, and/or
the vehicle doors are closed.

When the activation conditions have been met, the automation mode can be activated, optionally without further operator input by the driver, and the vehicle 100 can be maneuvered along the recorded trajectory (see step 215). Moreover, the trajectory can be displayed in the display 400, the trajectory display being continually updated to reflect the movement of the motor vehicle 100 during the automated maneuvering.

As described at the outset, an offer to carry out a previously recorded driving maneuver (according to step 207) may be overlooked by the driver of the vehicle 100. Furthermore, the driver may feel uncomfortable about evaluating a displayed offer and, as necessary, accepting the displayed offer while manually driving the vehicle 100.

The driving system can be designed to identify, prior to the arrival at the proximity region 1, the near region 2, and/or the activation region 3 of the recorded trajectory 5 for a recorded driving maneuver, that the vehicle 100 is approaching a destination, for which a stored driving maneuver exists. In particular, the driving system can be designed to identify, on the basis of the destination of a driving route which has been planned (on a navigation system of the vehicle 100), that a recorded driving maneuver exists for the destination of the planned driving route. This can be identified, e.g., directly in response to the input of the destination by the user of the vehicle 100.

An offer to carry out the recorded driving maneuver in an automated manner can then be output to the user of the vehicle 100 (e.g., via the user interface 103 of the vehicle 100) when the destination is specified and/or when the driving route to the destination is planned (e.g., prior to the beginning of the journey to the destination). The driver can then accept the offer (optionally prior to the journey to the destination). The steps 207 and/or 208 of the method 200 from FIG. 2a can therefore be carried out prior to the arrival at the destination (in particular prior to the arrival at the proximity region 1), preferably prior to the beginning of the journey to the destination (and the steps 207 and/or 208 are therefore omitted from the method 200).

When the vehicle 100 approaches the proximity region 1 of the recorded driving maneuver (with the recorded trajectory 5), the localization of the vehicle 100 relative to the recorded trajectory 5 can be started (see steps 203, 204 of the method 200), as is described in conjunction with FIGS. 2a and 2b. In particular, the recorded trajectory 5 can be positioned within the vehicle coordinate system in order to be able to determine the recorded trajectory 5, and in particular one or more possible activation points on the recorded trajectory 5, with increased accuracy.

When the vehicle 100 enters the near region 2 of the recorded driving maneuver, the driver of the vehicle 100 can be notified, optionally via an output of a message, that the vehicle 100 is located in close proximity to the recorded trajectory 5. A preliminary offer for the recorded driving maneuver (step 207) does not need to be output, since the user has already accepted the offer to carry out the recorded driving maneuver in an automated manner. Optionally, support information can be output (step 209) in order to assist the user of the vehicle 100 in driving to a possible activation point (e.g., to the activation region 3) of the recorded driving maneuver.

When the vehicle arrives at a possible activation point (e.g., the activation region 3), a stop request can be output (step 211), and the recorded driving maneuver can be carried out in an automated manner (as described in conjunction with FIG. 2b).

The driving system can therefore allow the driver of a vehicle 100 to select a recorded driving maneuver (in particular a recorded parking or positioning maneuver) as soon as the driver's intention to terminate his/her driving at the location of the recorded driving maneuver is identified. The automated execution of the recorded driving maneuver is then automatically activated as soon as the vehicle 100 comes close enough to the recorded driving maneuver (e.g., as soon as the vehicle 100 has arrived at the near region 2 or the activation region 3 of the recorded driving maneuver).

Within the framework of planning a driving route for a journey with the vehicle 100, the destination 602 of the journey can be specified by means of a driver input into the navigation system, as is shown in FIG. 6 by way of example. The destination 602 can be entered, e.g., into an input field 601 of the display 400 of the navigation system provided therefor. The destination 602 (in particular the GNSS coordinates of the destination) can be compared to the list of recorded driving maneuvers (in particular to the GNSS coordinates of the individual recorded driving maneuvers). On the basis thereof, it can be identified whether a recorded driving maneuver is available for the destination 602. When this is the case, the driver of the vehicle 100 can be offered the recorded driving maneuver (already within the framework of the planning of the driving route) which is available at the destination 602. For this purpose, a selection field 404 can be displayed, in which the identified driving maneuver is displayed and can be selected by the driver (e.g., by touch). By accepting the offer, the output of a (further) offer upon arrival at the proximity region 1 and/or the near region 2 of the recorded driving maneuver can be omitted. This enables the comfort for the driver of the vehicle 100 to be increased.

When the driver does not accept the offer to carry out the identified driving maneuver in an automated manner at the destination 602, the preliminary offer according to step 207 can be output at the destination 602 (as shown in the method 200 from FIGS. 2a and 2b), which preliminary offer the driver can then accept (step 208).

In a specific example, a driver can record a parking maneuver in a garage. Position data (in particular GNSS coordinates) for this parking maneuver can be stored (e.g., position data for the one or more possible activation point(s) and/or for the activation region 3).

When the driver, on a subsequent journey, enters the garage as the destination 602 into a navigation system (of the vehicle 100), the destination 602 (in particular the GNSS coordinates of the destination) can be compared to the position data of the recorded parking maneuver at this point in time. When the destination 602 is entered into the navigation system, the driver can be directly queried (e.g., via the user interface 103) as to whether the vehicle should be driven into the garage in an automated manner upon arrival at the destination 602 (therefore, an offer to carry out the recorded parking maneuver in an automated manner can be output). When the driver accepts the offer, the recorded parking maneuver is automatically selected as soon as the vehicle 100 is located close enough to the recorded trajectory 5 (e.g., as soon as the driver arrives at the proximity region 1, the near region 2, or the activation region 3 of the recorded trajectory 5). A new output of an offer upon arrival at the proximity region 1, the near region 2, or the activation region 3 of the recorded trajectory 5 can be prevented. This allows for a seamless transition between the (optionally manual) driving of the vehicle 100 to the destination 602 and the automated execution of the recorded parking maneuver.

FIG. 5 shows a flowchart of an (optionally computer-implemented) method 500 for carrying out a recorded driving maneuver of a motor vehicle 100 in an automated manner. The automatic execution of the recorded driving maneuver can include, in particular, the automatic maneuvering of the vehicle 100 on the basis of the recorded driving maneuver, in particular on the basis of the recorded trajectory 5 of the recorded driving maneuver.

The driving maneuver can have been recorded within the framework of a previous journey of the vehicle 100. The automated execution can include the automated longitudinal and/or lateral guidance of the vehicle 100 along a recorded trajectory 5 associated with the recorded driving maneuver.

The method 500 includes identifying 501 that a recorded driving maneuver is available at a destination 602 of a journey of the motor vehicle 100 specified by the user of the vehicle 100. The destination 602 can have been specified by the user in a navigation system of the vehicle 100. On the basis of the destination 602, in particular on the basis of the position data of the destination 602, it can be identified that a driving maneuver was recorded at the destination 602 during a previous journey, which driving maneuver can be reused during the current journey of the vehicle 100 (upon arrival at the destination 602). The recorded driving maneuver typically includes only a relatively small portion of the entire journey of the vehicle 100 (e.g., 10% or less, or 5% or less of the route).

The method 500 further includes, in response to the identified availability of a recorded driving maneuver at the destination 602, inducing 502 the motor vehicle 100 to be maneuvered at the destination 602 in an automated manner on the basis of the recorded driving maneuver. For this purpose, an offer to carry out the recorded driving maneuver in an automated manner at the destination 602 can be output prior to the arrival at the destination 602. The offer can be output, in particular, directly after the destination 602 has been entered into the navigation system of the vehicle 100. The offer can then be accepted by the user of the vehicle 100 (directly at the beginning of the journey to the destination 602). Furthermore, upon arrival at the destination 602, the automated execution of the recorded driving maneuver can be automatically induced (without a new offer being output). In other words, the automated maneuvering of the vehicle 100 on the basis of the recorded driving maneuver can be induced directly upon arrival at the destination 602. The offer is preferably not output again. Optionally, a message can be output, which notifies the driver of the vehicle 100 about the automatic execution of the recorded driving maneuver. Furthermore, the driver can be optionally enabled to stop and/or to prevent the automatic execution of the recorded driving maneuver by means of a user input (the recorded driving maneuver is automatically carried out when a user input is not entered in response to the output of the message).

Due to the measures described in this document, the comfort of a driving system for carrying out a recorded driving maneuver can be increased.

The present invention is not limited to the exemplary embodiments shown. In particular, it is important to note that the description and the figures are to illustrate only the principle of the provided methods, devices, and systems.

1.-15. (canceled)

16. A driving system for automated maneuvering of a motor vehicle based on a recorded driving maneuver of the motor vehicle, wherein the driving system is designed to:
identify that a recorded driving maneuver is available at a destination of a journey of the motor vehicle specified by a user; and
in response to an identification of the recorded driving maneuver, to induce the motor vehicle to be maneuvered at the destination in an automated manner based on the recorded driving maneuver.

17. The driving system according to claim 16, wherein the driving system is designed such that, when availability of the recorded driving maneuver at the destination is identified, the driving system
outputs an offer to the user, prior to arrival at the destination, to maneuver the motor vehicle in the automated manner based on the recorded driving maneuver; and
induces the motor vehicle to be maneuvered at the destination in the automated manner based on the recorded driving maneuver when the offer is accepted by the user.

18. The driving system according to claim 16, wherein the driving system is designed to:
detect, via a user interface, a user input for specifying a destination address; and
in response to detecting the user input, to induce an output, to the user, of an offer to maneuver the motor vehicle in the automated manner based on the recorded driving maneuver.

19. The driving system according to claim 16, wherein the driving system is designed to:
output an offer to the user to maneuver the motor vehicle in the automated manner based on the recorded driving maneuver within a framework of specifying the destination and/or planning a driving route to the destination; and/or
output the offer to the user, prior to or at a beginning of the journey to the destination, to maneuver the motor vehicle in the automated manner based on the recorded driving maneuver.

20. The driving system according to claim 16, wherein the driving system is designed to induce, within a framework of an input of the destination into a navigation system of the vehicle, an output of an offer, to the user, to maneuver the motor vehicle in the automated manner based on the recorded driving maneuver.

21. The driving system according to claim 16, wherein the driving system is designed to:
detect, prior to arrival at the destination, a user input of the user of the motor vehicle to accept an offer to maneuver the motor vehicle in the automated manner based on the recorded driving maneuver; and
in response to detecting the user input, to automatically induce the motor vehicle to be maneuvered at the destination in the automated manner based on the recorded driving maneuver upon the arrival at the destination without a new offer being output.

22. The driving system according to claim 16, wherein the driving system is designed such that, during the journey to the destination, the driving system:
detects that the motor vehicle has arrived at an activation region of the recorded driving maneuver; and
in response to detecting that the motor vehicle has arrived at the activation region, without an offer to maneuver the motor vehicle in the automated manner based on the recorded driving maneuver being output, automatically inducing the motor vehicle to be maneuvered at the destination in the automated manner based on the recorded driving maneuver.

23. The driving system according to claim 22, wherein the driving system is designed:
in response to a detected arrival at the activation region of the recorded driving maneuver, to induce the output of a stop request to stop the motor vehicle;
to detect that the motor vehicle has come to a standstill in the activation region; and
in response to detecting that the motor vehicle has come to the standstill, to guide the motor vehicle in an at least partially automated manner based on a recorded trajectory of the recorded driving maneuver in order to maneuver the motor vehicle in the automated manner based on the recorded driving maneuver.

24. The driving system according to claim 16, wherein the driving system is designed to:
detect, during the journey to the destination, that the motor vehicle has arrived at a near region of the recorded driving maneuver; and
in response to detecting that the motor vehicle has arrived at the near region, to automatically induce, without outputting an offer to maneuver the motor vehicle in the automated manner based on the recorded driving maneuver, an output of support information to assist the user of the vehicle during an approach to an activation region of the recorded driving maneuver.

25. The driving system according to claim 16, wherein the driving system is designed such that, during the journey to the destination, the driving system:
determines, based on Global Navigation Satellite System (GNSS) data and/or based on image data of at least one surroundings camera of the motor vehicle, that the motor vehicle has arrived at a proximity region of the recorded driving maneuver; and
in response to determining that the motor vehicle has arrived at the proximity region, automatically induces, without an offer to maneuver the motor vehicle in the automated manner based on the recorded driving maneuver being output:
a recorded trajectory of the recorded driving maneuver to be positioned relative to a vehicle coordinate system of the motor vehicle; and/or
an odometry-based distance of the motor vehicle to the recorded trajectory to be determined and/or repeatedly updated.

26. The driving system according to claim 25, wherein the driving system is designed to determine, based on the odometry-based distance, that the motor vehicle has arrived at a near region and/or an activation region of the recorded driving maneuver.

27. The driving system according to claim 16, wherein the driving system is designed to:
determine position data, including coordinates of a Global Navigation Satellite System (GNSS), of the destination;
read out of a memory unit, position data, including GNSS coordinates, of the recorded driving maneuver, relating to a proximity region, a near region, and/or an activation region of the recorded driving maneuver; and
detect, based on the position data of the destination and of the recorded driving maneuver, that the recorded driving maneuver is available at the destination.

28. The driving system according to claim 27, wherein the driving system is designed to:
determine position data for a plurality of different recorded driving maneuvers; and
identify, based on the position data of the destination and the position data for the plurality of recorded driving maneuvers, the recorded driving maneuver from the plurality of recorded driving maneuvers, which is available at the destination.

29. The driving system according to claim 16, wherein the driving system is designed in a recording mode to:
record a driving trajectory for a driving maneuver based on a path of travel traversed by a driver using the motor vehicle in a manual driving operation, and to store the driving trajectory as the recorded driving maneuver on a memory unit of the motor vehicle; and/or
store position data related to the recorded driving maneuver, including position data which allow a proximity region, a near region, and/or an activation region of the recorded driving maneuver to be determined; and
in an automation mode, during a new journey of the motor vehicle, to longitudinally and/or laterally guide the motor vehicle based on the recorded trajectory of the recorded driving maneuver in the automated manner in order to maneuver the motor vehicle in the automated manner based on the recorded driving maneuver.

30. A method for automated maneuvering of a motor vehicle based on a recorded driving maneuver of the motor vehicle, the method comprising:
identifying that a recorded driving maneuver is available at a destination of a journey of the motor vehicle specified by a user; and
in response to identifying that the recorded driving maneuver is available at the destination, inducing the motor vehicle to be maneuvered at the destination in an automated manner based on the recorded driving maneuver.
